(19) United States
(12) Patent Application Publication
(10) Pub. No.: US 2026/0225023 A1
(43) Pub. Date: Aug. 6, 2026

(54) CONDENSATE SEPARATOR OF AN AIR CONDITIONING SYSTEM

(71) Applicant: Axiom Space, Inc., Houston, TX (US)

(72) Inventors: Shray Chauhan, League City, TX (US); Christian Michael Cruzen, Friendswood, TX (US); Sam Cuu Nguyen, League City, TX (US); Matthew Allen Stallard, League City, TX (US)

(21) Appl. No.: 19/046,269

(22) Filed: Feb. 5, 2025

(51) Int. Cl. B01D 50/20; B01D 45/08; B01D 46/00; B01D 46/10; B01D 53/26; F24F 3/14

(52) U.S. Cl. CPC B01D 50/20; B01D 45/08; B01D 46/0035; B01D 46/106; B01D 53/265; F24F 3/14; B01D 2279/50; F24F 2003/1446

(57) ABSTRACT

A condensate separator includes an enclosure defining a cavity configured to receive an air flow having a liquid condensate entrained in the air flow. The condensate separator also includes a deflector assembly disposed in the cavity and configured to separate the liquid condensate from the air flow and to guide the liquid condensate toward an inner surface of the enclosure. The condensate separator also includes a filter disposed in the cavity and configured to receive the liquid condensate from the inner surface of the enclosure.

### BACKGROUND

This section is intended to introduce the reader to various aspects of art that may be related to various aspects of the present disclosure, which are described and/or claimed below. This discussion is intended as background information for the reader to facilitate a better understanding of the various aspects of the present disclosure. Accordingly, it is understood that these statements are to be read in this light, and not as admissions of prior art.

Air conditioning systems may employ a heat exchanger configured to control a temperature and/or humidity in a conditioned space by cooling an air flow directed to the conditioned space. For example, the air flow may be directed across or through the heat exchanger, and the heat exchanger may circulate a working fluid (e.g., cooling fluid), such as refrigerant, water, glycol, a combination of water and glycol, or other working fluid. As the air flow is cooled, gaseous and/or vaporous moisture within the air flow may condense into a liquid phase to form condensate. In such instances, the condensate may form and/or collect on surfaces of the heat exchanger. As the air flow is directed across the heat exchanger, the condensate (e.g., liquid droplets) may become entrained within the cooled air flow that is discharged from the heat exchanger. In traditional systems, the liquid condensate may be displaced from the heat exchanger and/or released from the air flow via force of gravity. Accordingly, traditional systems may include a condensate management system configured to capture the liquid condensate and to direct the liquid condensate to a dedicated area of the air conditioning system or away from the air conditioning system. Unfortunately, traditional terrestrial-based condensate management systems are ineffective in microgravity environments (e.g., spacecrafts, space stations, other spacefaring vehicles, and the like). Accordingly, it is now recognized that improved systems and methods for condensate separation and collection are desired.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a condensate separator includes an enclosure defining a cavity configured to receive an air flow having a liquid condensate entrained in the air flow. The condensate separator also includes a deflector assembly disposed in the cavity and configured to separate the liquid condensate from the air flow and to guide the liquid condensate toward an inner surface of the enclosure. The condensate separator also includes a filter disposed in the cavity and configured to receive the liquid condensate from the inner surface of the enclosure.

In another embodiment, an air conditioning system includes a condensate separator including an enclosure defining a cavity configured to receive an air flow from a heat exchanger of the air conditioning system, where a liquid condensate is entrained in the air flow. The air conditioning system also includes a deflector assembly disposed in the cavity of the condensate separator, where the deflector assembly includes deflectors arranged within the cavity and configured to separate the liquid condensate from the air flow and to guide the liquid condensate toward an inner surface of the enclosure. The air conditioning system also includes a filter disposed within a recess of the enclosure, where the filter is configured to receive the liquid condensate from the inner surface of the enclosure, and where the filter is disposed downstream of the deflector assembly relative to a flow direction of the air flow through the enclosure.

In still another embodiment, a method of separating a liquid condensate from an air flow includes receiving the air flow and the liquid condensate entrained in the air flow into a cavity of an enclosure of a condensate separator via an inlet of the enclosure. The method also includes impinging the air flow and the liquid condensate entrained in the air flow against a deflector assembly disposed in the cavity. The method also includes guiding the liquid condensate separated from the air flow via the deflector assembly toward an inner surface of the enclosure. The method also includes guiding the liquid condensate via the inner surface of the enclosure to a filter disposed in the cavity. The method also includes discharging the liquid condensate from the enclosure via a liquid outlet formed in the enclosure. The method also includes directing the air flow through an outlet of the enclosure.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an air conditioning system for a microgravity environment, in accordance with an aspect of the present disclosure;

FIG. 2 is a perspective view of an embodiment of a condensate separator for an air conditioning system, in accordance with an aspect of the present disclosure;

FIG. 3 is a perspective view of an embodiment of a condensate separator for an air conditioning system, illustrating internal components of the condensate separator, in accordance with an aspect of the present disclosure;

FIG. 4 is a cross-sectional side view of an embodiment of a condensate separator for an air conditioning system, in accordance with an aspect of the present disclosure;

FIG. 5 is a perspective view of an embodiment of a condensate separator for an air conditioning system, in accordance with an aspect of the present disclosure;

FIG. 6 is a perspective view of an embodiment of a condensate separator for an air conditioning system, illustrating internal components of the condensate separator, in accordance with an aspect of the present disclosure;

FIG. 7 is a cross-sectional side view of an embodiment of a condensate separator for an air conditioning system, in accordance with an aspect of the present disclosure;

FIG. 8 is a schematic of a portion of an embodiment of a condensate separator for an air conditioning system, illustrating use of a filter of the condensate separator, in accordance with an aspect of the present disclosure;

FIG. 9 is a schematic of a portion of an embodiment of a condensate separator for an air conditioning system, illustrating use of a filter of the condensate separator, in accordance with an aspect of the present disclosure;

FIG. 10 is a schematic of a portion of an embodiment of a condensate separator for an air conditioning system, illustrating use of a filter of the condensate separator, in accordance with an aspect of the present disclosure;

FIG. 11 is a multiview projection of an embodiment of a mesh filter of a condensate separator of an air conditioning system, illustrating a straight weave configuration of the mesh filter, in accordance with an aspect of the present disclosure;

FIG. 12 is a multiview projection of an embodiment of a mesh filter of a condensate separator of an air conditioning system, illustrating a plain Dutch weave configuration of the mesh filter, in accordance with an aspect of the present disclosure;

FIG. 13 is a multiview projection of an embodiment of a mesh filter of a condensate separator of an air conditioning system, illustrating a twill Dutch weave configuration of the mesh filter, in accordance with an aspect of the present disclosure;

FIG. 14 is a process flow diagram illustrating an embodiment of a method of operating an air conditioning system including a condensate separator, in accordance with an aspect of the present disclosure; and

FIG. 15 is a process flow diagram illustrating an embodiment of a method of separating a liquid condensate from an air flow via a condensate separator, in accordance with an aspect of the present disclosure.

### DETAILED DESCRIPTION

One or more specific embodiments will be described below. The described embodiments are examples of the presently disclosed techniques. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used here, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/−5%, within +/−4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art, and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

The present disclosure relates generally to air conditioning systems suitable for operation in microgravity environments. More particularly, the present disclosure relates to a condensate separator of an air conditioning system. The condensate separator is configured to remove liquid condensate (e.g., liquid droplets, condensate droplets) from an air flow (e.g., cooled air flow) in a microgravity environment. In other words, embodiments of the condensate separator disclosed here are configured to remove condensate from an air flow without assistance from, and/or reliance upon, gravitational acceleration. The present techniques therefore enable improved separation of liquid condensate from air flows in air conditioning systems utilized in microgravity environments. It should be noted that “air,” as used in accordance with the present disclosure, may include breathable gases having constituents and/or compositions comparable to or different than those found in atmospheric air on earth, such as breathable gases having constituents and/or compositions that are safely employed in spacecrafts, space stations, other spacefaring vehicles, and the like. As an example, “air” may include breathable gases having an Oxygen-to-Nitrogen ratio comparable to or different than atmospheric air on Earth. Additionally or alternatively, “air” may include breathable gases lacking Argon and/or other trace components found in atmospheric air on Earth. In other words, while ‘air’ in accordance with the present disclosure encompass atmospheric air on Earth, it may also encompass other types of breathable gases safely employed in occupied spaces formed in other environments (e.g., microgravity environments), such as in spacecrafts, space stations, other spacefaring vehicles, and the like.

In accordance with the present disclosure, an air conditioning system (e.g., suitable for microgravity environments) may include a fan or blower and a heat exchanger configured to enable regulation of air temperature and humidity in a conditioned space (e.g., cabin, compartment, module). For example, the fan or blower may generate an air flow that is directed across the heat exchanger, and the heat exchanger may establish a heat exchange relationship between the air flow and a working fluid (e.g., cooling fluid, refrigerant, water, glycol, a combination of water and glycol, etc.) circulated through the heat exchanger, thereby enabling cooling of the air flow. In some instances, the heat exchanger may be utilized to cool the air flow to reduce humidity (e.g., humidity level, moisture content) in the conditioned space. As will be appreciated, gaseous and/or vaporous moisture within the air flow may condense into a liquid phase to form condensate (e.g., liquid condensate, liquid droplets, condensate droplets) as the air flow is cooled. The condensate may form and/or collect on a surface of the heat exchanger. The condensate formed and/or collected on the surface of the heat exchanger may become entrained within the cooled air flow as the cooled air flow is discharged from the heat exchanger. It is desirable to remove the liquid condensate from the air flow before the air flow is directed or provided to the conditioned space or other intended destination, such as other componentry of the air conditioning system. Accordingly, the present enclosure is directed to a condensate separator configured to be disposed downstream of the heat exchanger. In the manner described in detail below, the condensate separator may receive the air flow and separate entrained liquid condensate from the air flow.

In microgravity environments, gravitational acceleration may not be relied upon to facilitate or assist in the removal of liquid condensate from the heat exchanger, such as a condensing surface of the heat exchanger, or the cooled air flow. Accordingly, air conditioning systems according to the present disclosure employ a condensate separator configured to remove liquid condensate (e.g., liquid droplets) from the cooled air flow without the assistance of gravitational acceleration. For example, the condensate separator may include an enclosure (e.g., housing) defining a cavity, a deflector assembly (e.g., a baffle assembly) disposed within the cavity, and a mesh filter (e.g., a filter) disposed within the cavity. In some embodiments, the enclosure and the cavity may each include a generally cylindrical shape and/or geometry configured to accommodate the deflector assembly and the mesh filter. Additionally or alternatively, the mesh filter may be disposed within the cavity adjacent to an outlet (e.g., air flow outlet) defined by the enclosure, while the deflector assembly may be disposed within the cavity between the mesh filter and an inlet (e.g., air flow inlet) defined by the enclosure.

The deflector assembly may include a plurality of deflectors configured to direct the air flow through the cavity and enable separation of liquid condensate from the air flow. For example, in some embodiments, the deflector assembly includes at least one conical deflector (e.g., conical baffle) and at least one frustoconical deflector (e.g., frustoconical baffle) in a stacked and spaced arrangement (e.g., referred to as a stack), although the deflector(s) may include other suitable shapes, geometries, and/or configurations in other embodiments. In an embodiment, the at least one conical deflector and the at least one frustoconical deflector may be stacked along an axis (e.g., central axis, longitudinal axis) of the condensate separator, the axis extending along a direction of the air flow into the condensate separator. For example, the frustoconical deflector may be positioned upstream of the conical deflector relative to the direction of the air flow through the enclosure and the cavity, and the frustoconical deflector may include an opening (e.g., a central opening) formed in an upstream end of the frustoconical deflector. The opening formed in the frustoconical deflector is configured to enable a portion of the air flow within the cavity to flow through the opening to impinge against (e.g., contact) the conical deflector. The plurality of deflectors may be coupled to an inner surface of the enclosure, such as via one or more ribs, for example. More detailed discussion regarding the orientation, sequencing, and other aspects of the plurality of deflectors of the deflector assembly will be provided with reference to the drawings.

As the air flow is directed through the enclosure of the condensate separator, the air flow may impinge against the plurality of deflectors. In general, as the air flow impinges against and flows across the deflectors, liquid condensate entrained within the air flow may collect on surfaces (e.g., upstream facing surfaces) of the deflectors. Liquid condensate (e.g., liquid droplets) that accumulates on the surfaces of the deflectors may then be forced to flow along the deflector surfaces by the air flow. In particular, the liquid condensate may flow along the deflector surfaces toward the inner surface of the enclosure. The liquid condensate may then flow from the deflector surfaces onto the inner surface of the enclosure, and the air flow may force the liquid condensate to flow along the inner surface of the enclosure, toward the mesh filter, and into the mesh filter. The mesh filter may include a woven material and may have an annular configuration (e.g., ring-shape) extending along the inner surface of the enclosure. In the manner described below, the mesh filter may capture the liquid condensate from the inner surface of the enclosure. The mesh filter extending along the inner surface of the enclosure may generally surround (e.g., encircle) an air flow path within the cavity. Thus, the mesh filter may enable the air flow to flow toward the outlet of the enclosure while retaining the liquid condensate to block re-entrainment of the liquid condensate within the air flow exiting the enclosure. In some embodiments, the mesh filter is wetted (e.g., via a process referred to as priming or saturating in certain instances of the present disclosure) with a liquid (e.g., water) prior to operation of the condensate separator in the manner described above. Wetting, priming, or saturating the mesh filter may, among other technical benefits, promote flow of the liquid condensate into the mesh filter from the inner surface of the enclosure, as well as flow of the condensate out of the condensate separator (e.g., via a pump). Wetting, priming, or saturating the mesh filter with a liquid may also enable the mesh filter to function as a bridge that further blocks the captured liquid condensate present at the mesh filter from becoming dislodged and entrained within the air flow. That is, the mesh filter functioning as the bridge may enable the liquid condensate to flow freely via surface tension and relatively low static pressure (e.g., where the force is exerted by adhesion of the liquid condensate via surface tension).

A pump (e.g., external pump) may be fluidly coupled to the condensate separator to enable removal of captured liquid condensate from the condensate separator. In particular, the pump may be fluidly coupled to a volume (e.g., reservoir, recess) adjacent to the mesh filter within which the captured liquid condensate may accumulate. The pump may generate a pressure differential (e.g., suction force) that draws the liquid condensate droplets through the mesh filter, into the volume, and toward a condensate discharge port of the enclosure. A condensate removal conduit may be fluidly coupled to the condensate discharge port and may form part of a liquid (e.g., water) pathway associated with the air conditioning system and/or other componentry (e.g., a drinking water assembly). Thus, the condensate removal conduit may direct the liquid condensate to another desired system, component, or location.

By removing liquid condensate entrained within the air flow cooled by the heat exchanger of the air conditioning system, the condensate separator disclosed here enables supply of dehumidified air toward a conditioned space or other system conditioned by the air conditioning system. In addition, removal of moisture from the air flow may also enhance protection of systems and components that may be exposed to the air flow and may otherwise be adversely affected by presence of moisture within the air flow. Embodiments of the condensate separator disclosed here may be configured operate with a condensate capture efficiency of 90 percent, 95 percent, 99 percent, or more. That is, the condensate separator may remove 90 percent, 95 percent, 99 percent, or more of the liquid condensate entrained in the air flow cooled by the heat exchanger and received by the condensate separator. As described above, the condensate separator of the present disclosure is configured to effectively remove liquid condensate entrained within the air flow without reliance upon gravitational acceleration, which enables the use of the condensate separator in microgravity environments. Other technical benefits include reduced footprint, a reduced number of moving parts, reduced energy usage, and/or reduced weight over traditional systems and associated techniques. These and other features of the present disclosure are described in greater detail below with reference to the drawings.

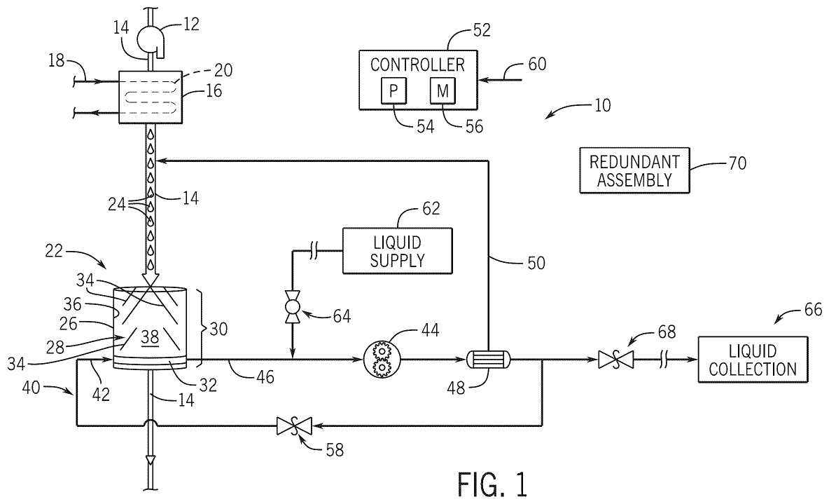

FIG. 1 is a schematic diagram of an embodiment of an air conditioning system 10 configured for implementation in a microgravity environment (e.g., a weightless environment). As used here, a “microgravity environment” may refer to an environment in which the acceleration due to gravity acting on a spacecraft/space vehicle is matched by the rate of change of velocity of the spacecraft/space vehicle in its orbit, such that the relative motion of objects within or attached to the vehicle is said to be in “free-fall,” such as outer space (e.g., low Earth orbit). For example, the air conditioning system 10 may be implemented in a spacecraft, such as a space travel vehicle or space station. The air conditioning system 10 includes a fan 12 (e.g., blower) configured to generate an air flow 14 and a heat exchanger 16 configured to condition the air flow 14. The air flow 14 may include cabin or return air flow (e.g., received from a cabin or conditioned space within a spacecraft), ventilation or supply air (e.g., received from an electrolysis or air filtration assembly), and/or any other suitable air flow. The heat exchanger 16 is also configured to receive and circulate a working fluid 18 (e.g., refrigerant, water, glycol, a combination of water and glycol, etc.) through the heat exchanger 16. For example, the heat exchanger 16 may include a coil 20 configured to direct a flow of the working fluid 18 therethrough. However, it should be appreciated that the heat exchanger 16 may have any other suitable configuration.

As the fan 12 directs the air flow 14 across and/or through the heat exchanger 16, the air flow 14 is placed in a heat exchange relationship with the working fluid 18. In this way, the heat exchanger 16 is configured to condition the air flow 14, such as by modifying a temperature and/or humidity content of the air flow 14. During operation of the heat exchanger 16 to cool the air flow 14, moisture within the air flow 14 may condense and form liquid condensate (e.g., liquid droplets, condensate droplets). The liquid condensate may form and/or accumulate on a surface (e.g., plate, fin, tube, coil, shell) of the heat exchanger 16. The liquid condensate forming on the heat exchanger 16 will begin as tiny particles that gradually combine and grow as more liquid condensate forms on the surface of the heat exchanger 16. As the air flow 14 is directed across and/or through the heat exchanger 16, droplets of liquid condensate collected on the heat exchanger 16 may be dislodged by the air flow 14 and may become entrained with the air flow 14 in the heat exchanger 16 (e.g., prior to the air flow 14 being discharged from the heat exchanger 16). Accordingly, as shown, the air flow 14 output from the heat exchanger 16 is entrained with liquid condensate 24 (e.g., condensate droplets, liquid droplets). It is desirable to remove the entrained liquid condensate 24 from the air flow 14 prior to delivery of the air flow 14 to a system or location serviced by the air conditioning system 10, such as other componentry of the air conditioning system 10, a conditioned space or cabin (e.g., within a spacecraft) that receives the air flow 14, and so forth.

In accordance with the present disclosure, the air conditioning system 10 includes a condensate separator 22 (e.g., microgravity condensate separator) configured to enable separation of the liquid condensate 24 (e.g., condensate droplets, liquid droplets) entrained within the air flow 14 that is conditioned (e.g., cooled) and discharged by the heat exchanger 16. The condensate separator 22 may therefore be positioned downstream of the heat exchanger 16 relative to a flow direction of the air flow 14 through the air conditioning system 10. The condensate separator 22 is configured to operate to separate the liquid condensate 24 from the air flow 14 without the assistance of, or reliance upon, gravitational acceleration. The condensate separator 22 includes an enclosure 26 (e.g., housing, cylindrical enclosure) defining a cavity 28 (e.g., cylindrical cavity). Additionally, the condensate separator 22 includes a deflector assembly 30 (e.g., baffle assembly, deflector arrangement) and a filter 32 (e.g., mesh filter, membrane, porous membrane) disposed within the cavity 28, as shown. The condensate separator 22 may not include parts, components, or elements that move (e.g., rotate, translate, reciprocate, pivot, etc.) during operation of the condensate separator 22. That is, the condensate separator 22 may facilitate and enable separation of liquid condensate 24 from the air flow 14 without powered or moving parts components. As a result, the present techniques provide a cost-effective, reliable system that enables separation of liquid condensate 24 from the air flow 14. Indeed, embodiments of the condensate separator 22 disclosed here may be readily manufactured and operated with improved reliability, reduced maintenance, reduced wear and degradation, and so forth.

The deflector assembly 30 includes one or more deflectors 34 configured to deflect the air flow 14 received by the condensate separator 22 and enable separation of the liquid condensate 24 from the air flow 14. The deflector assembly 30 is also configured to collect (e.g., capture) and guide the liquid condensate 24 toward the filter 32 disposed within the enclosure 26. To this end, the deflector assembly 30 may be coupled (e.g., attached, directly coupled) to an inner surface 36 (e.g., inner wall) of the enclosure 26. The filter 32 may also be attached to the inner surface 36 of the enclosure 26. The filter 32 may generally surround (e.g., circumferentially surround) or encircle an air flow path 38 extending through the enclosure 26 and/or the cavity 28. As described further below, the filter 32 is configured to maintain separation of the liquid condensate 24 from the air flow 14, such that the air flow 14 may be discharged by the condensate separator 22 without or substantially without the liquid condensate 24 entrained with air flow 14. The liquid condensate 24 may then be separately discharged from the condensate separator 22.

The air flow 14 directed into the condensate separator 22 may impinge against one or more of the deflectors 34 (e.g., baffles) of the deflector assembly 30. To this end, the deflectors 34 are at least partially positioned within the air flow path 38 extending through the enclosure 26 and/or the cavity 28. As the air flow 14 impinges against the deflectors 34, the liquid condensate 24 (e.g., condensate droplets) entrained within the air flow 14 may accumulate on upstream facing surfaces of the deflectors 34. The liquid condensate 24 formed and/or disposed on the upstream facing surfaces of the deflectors 34 may also be forced to flow along the upstream facing surfaces by the air flow 14. Specifically, the deflectors 34 are configured to deflect and/or redirect the air flow 14 at least partially radially outward (e.g., relative to a central axis of the enclosure 26), and therefore the air flow 14 may force the liquid condensate 24 to flow along the upstream facing surfaces of the deflectors 34 toward the inner surface 36 of the enclosure 26. In some embodiments, the deflector assembly 30 may include one or more features configured to guide or otherwise enhance flow of the liquid condensate 24 along the deflectors 34 toward the inner surface 36 of the enclosure 26, as described further below.

The liquid condensate 24 may flow from the deflector assembly 30 onto the inner surface 36 of the enclosure 26. To this end, the deflector assembly 30 may include a configuration, arrangement, and/or other feature configured to enable transfer of the liquid condensate 24 from the deflectors 34 to the inner surface 36. Details of certain embodiments of the deflector assembly 30 are described further below with reference to subsequent drawings. The liquid condensate 24 directed onto the inner surface 36 of the enclosure 26 be further forced (e.g., via the air flow 14) to flow along the inner surface 36, such as in a downstream direction. More particularly, the liquid condensate 24 may flow along the inner surface 36 toward the filter 32 (e.g., mesh filter), such as via a force imparted to the liquid condensate 24 by the air flow 14.

The filter 32 may have an annular (e.g., ring-shaped) configuration that extends along the inner surface 36 of the enclosure 26. In some embodiments, the filter 32 may include a mesh and/or porous structure. For example, the filter 32 may include a woven material, such as a woven fabric, plastic (e.g., 3-D printed plastic), or metallic material (e.g., stainless steel), forming the annular configuration or shape extending along the inner surface 36 of the enclosure 26. The woven material may include, for example, a straight weave, a plain Dutch weave, or a twill Dutch weave. In some embodiments, the filter 32 may be wetted (e.g., primed, saturated) with a liquid prior to and/or during operation of the condensate separator 22 to remove the liquid condensate 24 from the air flow 14. For example, a liquid supply flow path 40 (e.g., liquid conduit, liquid circuit, liquid loop) may be employed to direct a liquid 42 (e.g., water) to the filter 32 to saturate the filter 32. To this end, the condensate separator 22 may be disposed along the liquid supply flow path 40. In some embodiments, the liquid supply flow path 40 may correspond to, or interact with, a gray water circuit employed in other contexts and/or for other purposes or functions. For example, the liquid supply flow path 40 may be a portion of and/or may extend from a gray water circuit that includes a purifier configured to produce drinking water. Wetting the filter 32 with the liquid 42 may promote flow of the liquid condensate 24 into and/or across the filter 32 from the inner surface 36 of the enclosure 26. Wetting the filter 32 with the liquid 42 may also enable the filter 32 to function as a barrier that further blocks (e.g., via surface tension of the liquid 42) the captured liquid condensate 24 present at the filter 32 from becoming dislodged and entrained within the air flow 14 directed along the air flow path 38.

In some embodiments, the liquid 42 is forced along the liquid supply flow path 40 via a pump 44 (e.g., external pump), which may be external to the condensate separator 22. The pump 44 may also be configured to enable removal of liquid condensate 24 separated from the air flow 14 and captured by the condensate separator 22. In the illustrated embodiment, the pump 44 fluidly coupled to the condensate separator 22 via the liquid supply flow path 40 and is disposed along the liquid supply flow path 40 downstream of the condensate separator 22. In operation, the pump 44 may generate a pressure differential (e.g., suction force, vacuum) across opposing sides of the filter 32 that draws the liquid condensate 24 across and/or through the filter 32. Additionally or alternatively, the pressure differential and/or force generated by the pump 44 may drive liquid condensate 24 drawn across the filter 32 to subsequently flow into a condensate removal conduit 46 of the liquid supply flow path 40. For example, the condensate removal conduit 46 may extend from the condensate separator 22 to the pump 44. Thus, in some embodiments, the liquid condensate 24 removed from the condensate separator 22 may become part of the liquid 42 circulated through the liquid supply flow path 40. Wetting the filter 32 with the liquid 42, as described above, may enable improved suction of the liquid condensate 24 by the external pump 44 and/or may block air bubbles from entering the condensate removal conduit 46.

As shown in the illustrated embodiment, a degasser 48 may be disposed along the liquid supply flow path 40 (e.g., downstream of the pump 44) to remove gas (e.g., air, gas bubbles) in the liquid 42 (e.g., liquid condensate 24) circulated through the liquid supply flow path 40. In some embodiments, air removed from the liquid 42 via the degasser 48 may be recycled and combined with the air flow 14. For example, degassed air 50 may be directed to combine with the air flow 14 downstream of the heat exchanger 16 and upstream of the condensate separator 22 (e.g., relative to a direction of the air flow 14 through the air conditioning system 10).

The air conditioning system 10 and/or other system incorporating the air conditioning system 10 may further include a controller 52 (e.g., control system, automation controller, controller assembly) configured to control one or more of the systems, components, and/or operations described here. The controller 52 may include processing circuitry 54 such as a microprocessor, which may execute software for controlling the components of the air conditioning system 10. The processing circuitry 54 may include multiple microprocessors, one or more “general-purpose” microprocessors, one or more special-purpose microprocessors, and/or one or more application specific integrated circuits (ASICS), or some combination thereof. For example, the processing circuitry 54 may include one or more reduced instruction set (RISC) processors. The controller 52 also includes a memory 56 (e.g., memory device, memory circuitry) that may store information, such as instructions, control software, look up tables, configuration data, and so forth. The memory 56 may include a volatile memory, such as random access memory (RAM), and/or a nonvolatile memory, such as read-only memory (ROM). The memory 56 may store a variety of information and may be used for various purposes. For example, the memory 56 may store processor-executable instructions including firmware or software for the processing circuitry 54 to execute, such as instructions for controlling components of the air conditioning system 10. In some embodiments, the memory 56 is a tangible, non-transitory, machine-readable-medium that may store machine-readable instructions for the processing circuitry 54 to execute. The memory 56 may include ROM, flash memory, a hard drive, or any other suitable optical, magnetic, or solid-state storage medium, or a combination thereof. The memory 56 may store data, instructions, and any other suitable information that enables one or more of the operations or functions described here.

As an example, the processing circuitry 54 may be configured to execute instructions stored on the memory 56 to control the pump 44 to circulate the liquid 42 through the liquid supply flow path 40 and/or to draw liquid condensate 24 out of the condensate separator 22. In some embodiments, a flow control device 58 (e.g., a valve) may be disposed along the liquid supply flow path 40 to regulate flow of the liquid 42, and the controller 52 may be configured to control operation of the flow control device 58. Additionally or alternatively, the controller 52 may be configured to control operation of the fan 12 (or blower), the heat exchanger 16, and/or other components of the air conditioning system 10. Moreover, the controller 52 may be configured to control any of the systems, components, operations, and/or functions described here based on the one or more inputs 60 (e.g., data, feedback, user input). The one or more inputs 60 may include, for example, a call for conditioning received from a thermostat, an input (e.g., sensor data) indicative of temperature of a fluid associated with the air conditioning system 10 or a conditioned space, an input (e.g., sensor data) indicative of pressure of a fluid associated with the air conditioning system 10 or a conditioned space, other sensor data, any combination thereof, and/or any other suitable input.

Additionally or alternatively, the controller 52 may control, via the processing circuitry 54, other components that may be incorporated and/or associated with the liquid supply flow path 40, such as a liquid supply 62, a valve 64 corresponding to the liquid supply 62, a liquid collection point 66 (e.g., container, reservoir), a valve 68 corresponding to the liquid collection point 66, and/or any other suitable components or operations. In certain embodiments, the liquid supply 62 is external to the air conditioning system 10 and/or the liquid collection point 66 is external to the air conditioning system 10. In the illustrated embodiment, the valve 64 may be operable (e.g., via the controller 52) to control one or more flow characteristics of liquid from the liquid supply 62 toward aspects of the air conditioning system 10, and the valve 68 may be operable (e.g., via the controller 52) to control one or more flow characteristics of liquid from the air conditioning system 10 toward the liquid collection point 66. In certain embodiments, the liquid supply 62 includes a container or reservoir and/or the liquid collection point 66 includes a container or reservoir. As previously described, the liquid condensate 24 removed from the air flow 14 and drawn into the liquid supply flow path 40 may be recycled and purified for use as drinking water, among other possible uses. In certain embodiments, one or more of the flow control device 58, the valve 64, or the valve 68 in the illustrated embodiment may be operable as a check valve that blocks backflow of the respective fluid directed therethrough.

In some embodiments, the air conditioning system 10 may include a redundant assembly 70 (e.g., redundant system). The redundant assembly 70 may include, for example, additional embodiments or instances of the fan 12, the heat exchanger 16, the condensate separator 22, and/or any other components described above. In general, the redundant assembly 70 and its components may be employed to maintain operation of the air conditioning system 10, such as during instances in which one or more components of the air conditioning system 10 described above (e.g., primary components) are inoperable (e.g., due to degradation, wear, maintenance, etc.). The controller 52 may configured to control operation of the redundant assembly 70 and its components, as similarly described above. For example, the controller 52 may be configured to identify non-operation of a particular component of the air conditioning system 10 (e.g., via the one or more of the inputs 60) and, in response, may initiate operation of a corresponding or redundant component of the redundant assembly 70.

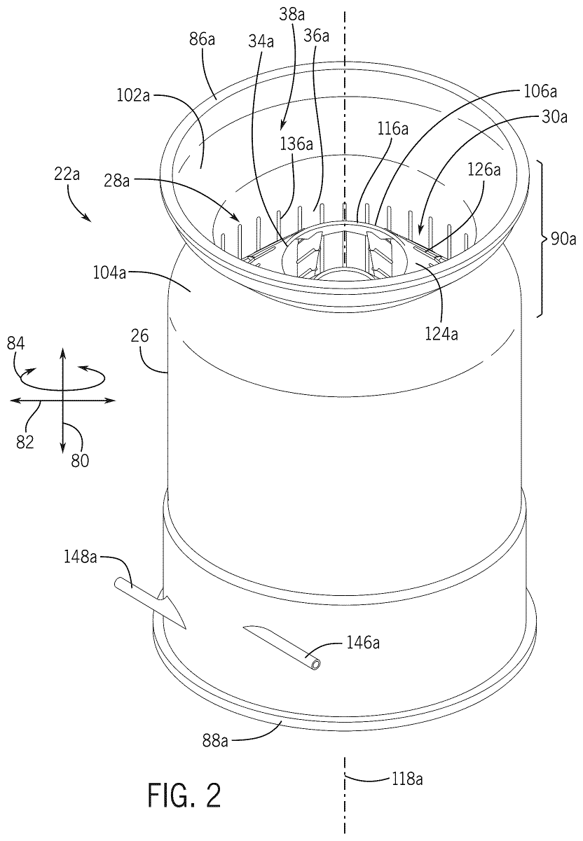

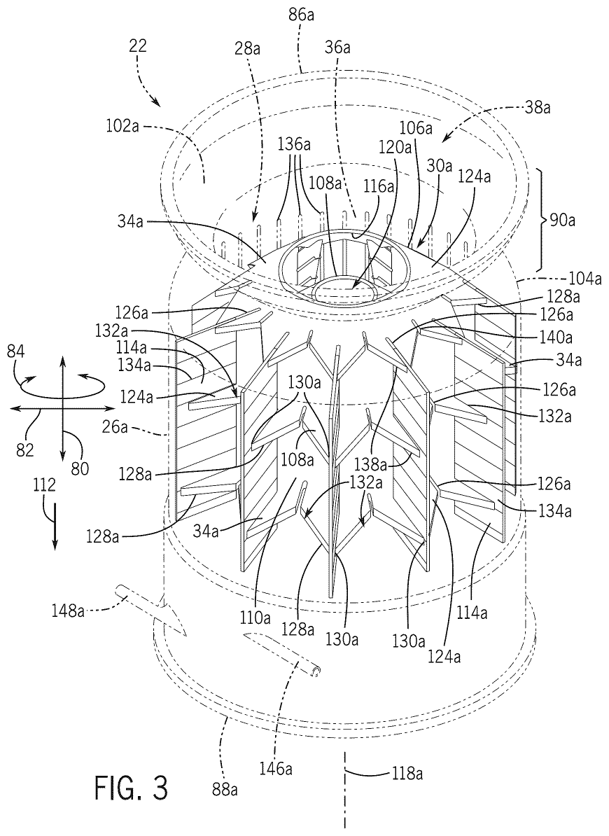

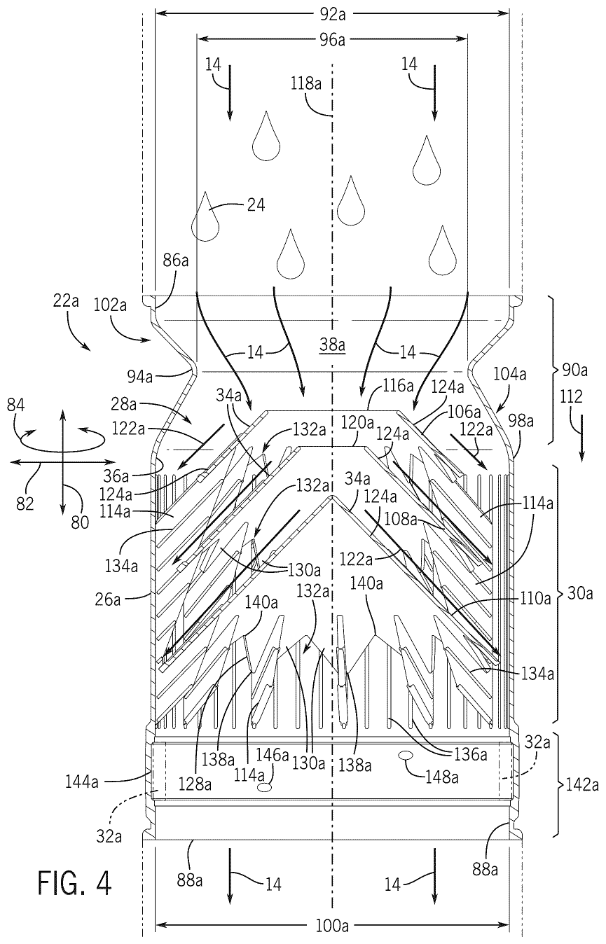

FIG. 2 is a perspective view of an embodiment of a condensate separator 22a that may be incorporated with the air conditioning system 10. FIG. 3 is a perspective view of an embodiment of the condensate separator 22a that may be incorporated with the air conditioning system 10, illustrating internal components of the condensate separator 22a. FIG. 4 is a cross-sectional side view of an embodiment of the condensate separator 22a that may be incorporated with the air conditioning system 10. FIGS. 2-4 are described concurrently below. Additionally, to facilitate the following discussion, the condensate separator 22a and its components may be described with reference to a longitudinal axis 80 (e.g., longitudinal direction), a radial axis 82 (e.g., radial direction), and a circumferential direction 84.

As previously described, the condensate separator 22a in the illustrated embodiment includes a deflector assembly 30a disposed in a cavity 28a formed by an enclosure 26a. The enclosure 26a also defines an inlet 86a configured to receive and direct the air flow 14 and the liquid condensate 24 entrained in the air flow 14 into the cavity 28a, and an outlet 88a configured to discharge the air flow 14 from the cavity 28a. The enclosure 26a further defines a throat section 90a. The throat section 90a may be configured to accelerate the air flow 14 toward the deflector assembly 30a, for example, via a Venturi effect generated by a narrowing of an air flow path 38a extending through the condensate separator 22a.

As shown in FIG. 4, the throat section 90a includes a first cross-sectional width 92a (e.g., first diameter, extending in the radial direction 82) at or proximate the inlet 86a. In some embodiments, the first cross-sectional width 92a may be approximately equal to a diameter of the inlet 86a of the enclosure 26a. The throat section 90a tapers radially inward (e.g., along the radial direction 82 and/or along the longitudinal direction 80) to a vertex 94a having a second cross-sectional width 96a (e.g., second diameter, extending in the radial direction 82) that is less than the first cross-sectional width 92a. From the vertex 94a, the throat section 90a flares radially outward (e.g., along the radial direction 82 and/or along the longitudinal direction 80) to a downstream end 98a of the throat section 90a. The portion of the enclosure 26a extending from the downstream end 98a of the throat section 90a to the outlet 88a may have a third cross-sectional width 100a (e.g., third diameter, extending in the radial direction 82a). The third cross-sectional width 100a is therefore greater than the second cross-sectional width 96a and may be approximately equal to the first cross-sectional width 92a. The throat section 90a may therefore define a funnel portion 102a extending along the longitudinal direction 80 between the inlet 86a and the vertex 94a and a diffuser portion 104a extending along the longitudinal direction 80 from the vertex 94a to the downstream end 98a of the throat section 90a. However, in other embodiments, the enclosure 26a may have other geometries and/or configurations. For example, the enclosure 26a may have a generally constant cross-sectional width from the vertex 94a of the throat section 90a to the outlet 88a. In other words, the throat section 90a may include the funnel portion 102a but may not include the diffuser portion 104a. In another embodiment, the enclosure 26a may have a generally constant cross-sectional width from the inlet 86a to the outlet 88a. In still another embodiment, the enclosure 26a may include a generally constant cross-sectional width, such as the second cross-sectional width 96a, from the vertex 94a to the outlet 88a. That is, the enclosure 26a may include the funnel portion 102a and not the diffuser portion 104a in certain embodiments.

As mentioned above, the deflector assembly 30a includes a plurality of deflectors 34a disposed within the cavity 28a and at least partially extending within the air flow path 38a defined within the enclosure 26a. The deflectors 34a may be disposed in a stacked arrangement within the cavity 28a. More specifically, the deflectors 34a may be arrayed along the longitudinal direction 80 and may be offset from one another along the longitudinal direction 80. The arrangement of the deflectors 34a and/or the configuration (e.g., shape, geometry) of each deflector 34a may be selected to enable desirable flow of the air flow 14 through the condensate separator 22a and to enable separation of the liquid condensate 24 from the air flow 14 within the condensate separator 22a. As shown in FIGS. 3 and 4, the deflectors 34a (e.g., baffles) include a first frustoconical deflector 106a (e.g., upstream deflector), a second frustoconical deflector 108a (e.g., midstream deflector), and a conical deflector 110a (e.g., downstream deflector). The first frustoconical deflector 106a is disposed upstream of the second frustoconical deflector 108a, and the second frustoconical deflector 108a is disposed upstream of the conical deflector 110a, relative to a flow direction 112 of the air flow 14 through the enclosure 26a (e.g., along the longitudinal direction 80). Each of the deflectors 106a, 108a, and 110a is coupled to the inner surface 36a of the enclosure 26a via a plurality of ribs 114a (e.g., fins, supports, extensions, braces, connectors). That is, the ribs 114a may be coupled (e.g., fixed, attached) to the inner surface 36a of the enclosure 26a and may extend radially inward (e.g., along the radial direction 82) into the cavity 28a, and each rib 114a may be coupled to (e.g., fixed, attached) the deflectors 106a, 108a, and 110a.

The first frustoconical deflector 106a includes a first central opening 116a that enables at least a portion of the air flow 14, including a portion of the liquid condensate 24 entrained in the air flow 14, to flow therethrough. In some embodiments, the first central opening 116a may be generally centered (e.g., coaxial, aligned) relative to a central axis 118a of the enclosure 26a. The second frustoconical deflector 108a includes a second central opening 120a that enables a portion of the air flow 14, including a portion of the liquid condensate 24 entrained in the air flow 14, to flow therethrough. The second central opening 120a may also be generally centered (e.g., coaxial, aligned) relative to the central axis 118a of the enclosure 26a. Thus, the first central opening 116a and the second central opening 120a opening may generally be coaxial and/or concentric with one another. As indicated by arrows 122a in FIG. 4, the air flow 14 flowing through the cavity 28a of the enclosure 26a may be redirected in an at least partially radially outward direction (e.g., relative to the central axis 118a, along radial direction 82) by one or more of the deflectors 106a, 108a, and 110a. As will be appreciated, a first portion of the air flow 14 received by the enclosure 26a may be redirected radially outward by the first frustoconical deflector 106a, a second portion of the air flow 14 may flow through the first central opening 116a of the first frustoconical deflector 106a and may be redirected by the second frustoconical deflector 108a, and a third portion of the air flow 14 may flow through the first central opening 116a of the first frustoconical deflector 106a and through the second central opening 120a of the second frustoconical deflector 108a and may be redirected by the conical deflector 110a.

As previously described, the liquid condensate 24 entrained within the air flow 14 may accumulate on the deflectors 106a, 108a, and 110a as the air flow 14 impinges against the deflectors 106a, 108a, and 110a. Specifically, the liquid condensate 24 may accumulate on a respective upstream surface 124a of each deflector 106a, 108a, and 110a, while the air flow 14 may continue to flow through the cavity 28a (e.g., along the air flow path 38a, as indicated by arrows 122a). In this way, the deflectors 106a, 108a, and 110a enable separation of the liquid condensate 24 from the air flow 14. As the air flow 14 continues to impinge against and flow along the upstream surfaces 124a of the deflectors 106a, 108a, and 110a, the air flow 14 may force the liquid condensate 24 accumulated on the deflectors 106a, 108a, and 110a to flow along the upstream surfaces 124a of the deflectors 106a, 108a, and 110a radially outward towards the inner surface 36a of the enclosure 26a.

In some embodiments, the upstream surfaces 124a of the deflectors 106a, 108a, and 110a may include surface features configured to enhance and/or facilitate flow of liquid condensate 24 along the upstream surfaces 124. For example, in the illustrated embodiment, the deflectors 106a, 108a, and 110a include ridges 126a (e.g., linear ridges, protrusions, extensions, extrusions, raised portions) illustrated in FIGS. 2 and 3 and extending from the upstream surfaces 124a. The ridges 126a may induce or promote a capillary action or effect in the flow of the liquid condensate 24 along the upstream surfaces 124a. That is, the liquid condensate 24 accumulated on the upstream surfaces 124a of the deflectors 106a, 108a, and 110a may flow along the upstream surfaces 124a (e.g., via force of the air flow 14) and may contact the ridges 126a. Intermolecular forces between the liquid condensate 24 and the ridges 126a may enhance flow of the liquid condensate 24 along the upstream surfaces 124a.

The liquid condensate 24 may flow along the upstream surfaces 124a of the deflectors 106a, 108a, and 110a until the liquid condensate 24 reaches a respective outer edge 128a (e.g., base edge, peripheral edge, downstream edge) of one of the deflectors 106a, 108a, and 110a. The outer edge 128a of each deflector 106a, 108a, and 110a may have any suitable geometry or configuration. For example, in the illustrated embodiment, the outer edge 128a of each deflector 106a, 108a, and 110a generally defines a serrated or stelliform geometry. That is, the outer edge 128a of each deflector 106a, 108a, and 110a defines a plurality of tips 130a (e.g., triangular tips, pointed tips, angular tips, extensions, projections, curvilinear projections) of the respective deflector 106a, 108a, and 110a. The plurality of tips 130a is arrayed circumferentially about the outer edge 128a of the respective deflector 106a, 108a, and 110a (e.g., relative to the central axis 118a). In other embodiments, the outer edge 128a may define any other suitable geometry of the respective deflector 106a, 108a, and 110a. For example, the outer edge 128a may define the plurality of tips 130a having rounded or curved edges. In any case, the plurality of tips 130a may define a plurality of passages 132a (e.g., gaps, spaces) therebetween. The plurality of passages 132a is also arrayed circumferentially about the outer edge 128a and enables flow of the air flow 14 therethrough and, thus, through the cavity 28a.

From the upstream surfaces 124a of the deflectors 106a, 108a, and 110a, the liquid condensate 24 may flow onto one of the ribs 114a. As described above, the ribs 114a may be coupled to the inner surface 36a of the enclosure 26a and may extend radially inward into the cavity 28a and couple to the deflectors 106a, 108a, and 110a. Liquid condensate 24 that reaches and accumulates at the outer edge 128a of one of the deflectors 106a, 108a, and 110a may contact and flow onto one of the ribs 114a (e.g., onto a surface of one of the ribs 114a). As similarly described above, the ribs 114a may also include ridges 134a (e.g., linear ribs, protrusions, extensions, extrusions, raised portions) extending from the surfaces of the ribs 114a. The ridges 134a of the ribs 114a may similarly facilitate and/or promote flow of the liquid condensate 24 along the surfaces of the ribs 114a. In some embodiments, the ridges 134a of the ribs 114a may extend linearly from one of the deflectors 106a, 108a, and 110a to the inner surface 36a of the enclosure 26a to promote flow of the liquid condensate 24 (e.g., via intermolecular forces, via a capillary effect) along the ribs 114a toward the inner surface 36a. It should be appreciated that the air flow 14 flowing through the cavity 28a may also promote or facilitate flow of the liquid condensate 24 along the surfaces of the ribs 114a from the deflectors 106a, 108a, and 110a to the inner surface 36a of the enclosure 26a.

The liquid condensate 24 flowing along the surfaces of the ribs 114a may reach an interface between the ribs 114a and the inner surface 36a of the enclosure 26a and may then flow onto the inner surface 36a of the enclosure 26a. Once the liquid condensate 24 flows onto the inner surface 36a of the enclosure 26a, the liquid condensate 24 may flow along the inner surface 36a in a downstream direction (e.g., along the flow direction 112 of the air flow 14, along the longitudinal direction 80). To this end, the inner surface 36a may also include ridges 136a (e.g., linear ridges, protrusions, extensions, extrusions, raised portions) extending from the inner surface 36a of the enclosure 26a. Specifically, the ridges 136a may extend radially inward (e.g., relative to the central axis 118a) from the inner surface 36a and into the cavity 28a. Additionally, the ridges 136a may generally extend (e.g., linearly extend) along the central axis 118a and/or in the longitudinal direction 80. In this way, the ridges 136a formed on the inner surface 36a may promote flow of the liquid condensate 24 (e.g., via intermolecular forces, via a capillary effect) in a generally downstream direction (e.g., in the flow direction 112 of the air flow 14). Indeed, the air flow 14 flowing through the cavity 28a may also promote or facilitate flow of the liquid condensate 24 along the inner surface 36a of the enclosure 26a. In some implementations, the ridges 136a may block flow of the liquid condensate 24 along the inner surface 36 in the circumferential direction 84a.

The ribs 114a may be coupled to the deflectors 106a, 108a, and 110a at any suitable location along the respective outer edges 128a of the deflectors 106a, 108a, and 110a. For example, in the illustrated embodiment, the ribs 114a are attached to the deflectors 106a, 108a, and 110a at a respective outer vertex 138a (e.g., peak, distal point) defined by one of the plurality of tips 130a. In other embodiments, one or more of the ribs 114a may be attached to deflectors 106a, 108a, and 110a at an inner vertex 140a formed between adjacent tips 130a of the plurality of tips 130a of one or more of the deflectors 106a, 108a, and 110a. Further, in some embodiments, one or more of the ribs 114a may be attached to the outer vertices 138a of one of the deflectors 106a, 108a, and 110a and may be attached to the inner vertices 140a of another of the deflectors 106a, 108a, and 110a. In such an embodiment, two or more of the deflectors 106a, 108a, and 110a may be offset from one another in the circumferential direction 84. That is, the respective plurality of tips 130a defined by one of the deflectors 106a, 108a, and 110a may be circumferentially offset from the respective plurality of tips 130 defined by another of the deflectors 106a, 108a, and 110a.

The liquid condensate 24 may flow along the inner surface 36a of the enclosure 26a and may ultimately flow to the filter 32a of the condensate separator 22a, as illustrated in FIG. 4. For example, the filter 32a may be disposed within a filter section 142a of the enclosure 26a that is offset from the deflector assembly 30a along the longitudinal direction 80. Specifically, the filter section 142a is disposed within the enclosure 26a downstream of the deflector assembly 30a relative to the flow direction 112 of the air flow 14. In some embodiments, the filter 32a may be disposed within a recess 144a (e.g., formed in the inner surface 36a) of the enclosure 26a. As discussed above, the filter 32a may be wetted (e.g., primed, saturated) with the liquid 42 illustrated in FIG. 1 prior to operation of the condensate separator 22a. To this end, the enclosure 26a includes a liquid inlet 146a configured to fluidly couple to the liquid supply flow path 40 illustrated in FIG. 1 and a liquid outlet 148a configured to fluidly couple to the liquid supply flow path 40. The liquid inlet 146a may direct the liquid 42 from the liquid supply flow path 40 into the enclosure 26a (e.g., into the recess 144a) to contact the filter 32a. The liquid outlet 148a may direct the liquid 42, as well as liquid condensate 24 accumulated by the filter 32a, out of the enclosure 26a and into the liquid supply flow path 40. For example, the pump 44 illustrated in FIG. 1 may be operated to supply the liquid 42 to the condensate separator 22a and/or to draw the liquid 42 and the liquid condensate 24 out of the condensate separator 22a. The liquid inlet 146a and the liquid outlet 148a may be arranged along the enclosure 26a in any suitable configuration. For example, the liquid outlet 148a may be disposed closer to the outlet 88a of the enclosure 26a (e.g., along the longitudinal direction 80) than the liquid inlet 146a, in some embodiments. Details and operation of the filter 32a and filter section 142a are described further below.

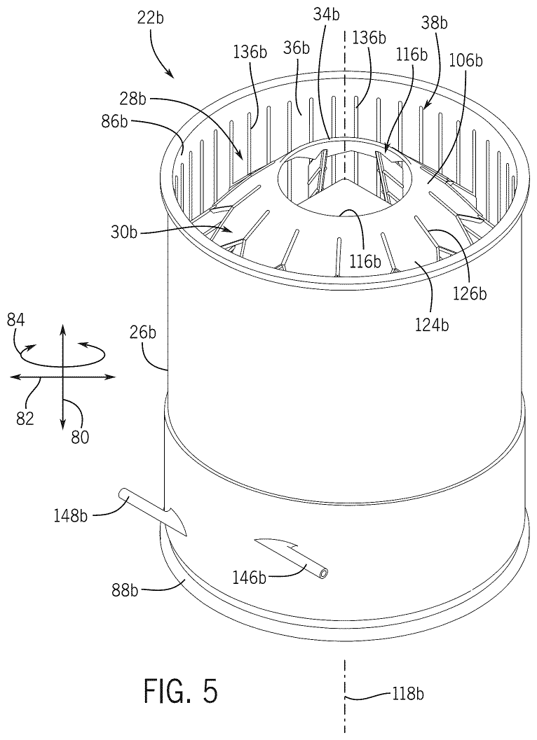

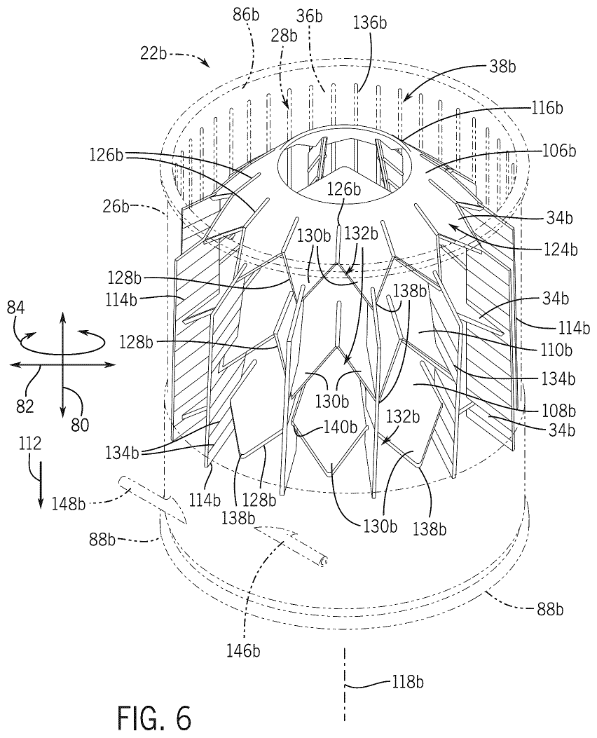

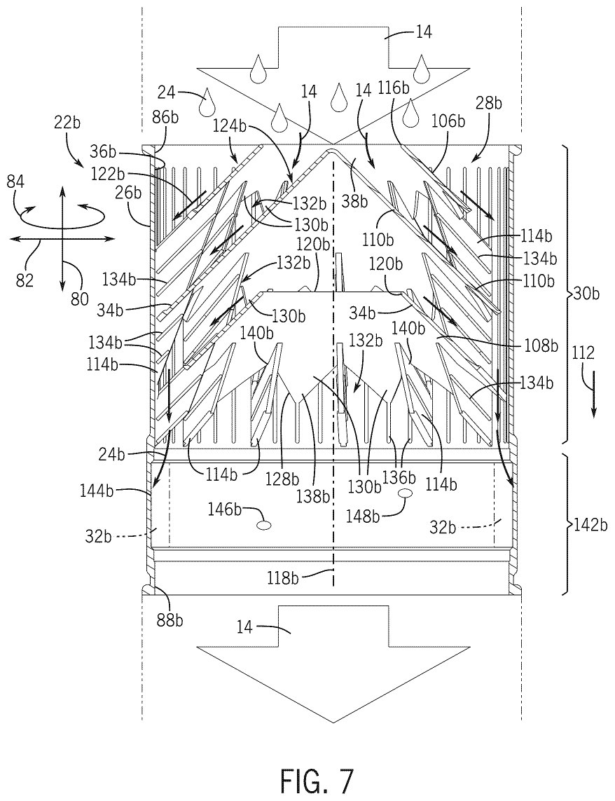

FIG. 5 is a perspective view of an embodiment of a condensate separator 22b that may be incorporated with the air conditioning system 10. FIG. 6 is a perspective view of an embodiment of the condensate separator 22b that may be incorporated with the air conditioning system 10, illustrating internal components of the condensate separator 22b. FIG. 7 is a cross-sectional side view of an embodiment of the condensate separator 22b that may be incorporated with the air conditioning system 10. FIGS. 5-7 are described concurrently below.

In the illustrated embodiment, an enclosure 26b of the condensate separator 22b (e.g., cylindrical enclosure) includes a generally cylindrical geometry from an inlet 86b of the enclosure 26b to an outlet 88b of the enclosure 26b. The condensate separator 22b includes a deflector assembly 30b having a plurality of deflectors 34b, where the deflectors 34b include, as shown in FIGS. 6 and 7, a first frustoconical deflector 106b having a first central opening 116b, a second frustoconical deflector 108b having a second central opening 120b illustrated in FIG. 7, and a conical deflector 110b. The first central opening 116b of the first frustoconical deflector 106b may permit a portion of the air flow 14 and a portion of the liquid condensate 24 to flow therethrough, and the second central opening 120b of the conical deflector 110b may permit a portion of the air flow 14 and a portion of the liquid condensate 24 to flow therethrough. As previously described, portions of the air flow 14 and the liquid condensate 24 may also flow at least partially radially outward (e.g., in the radial direction 82), as denoted by arrows 122b.

In the illustrated embodiment, the first frustoconical deflector 106b is an upstream deflector, the conical deflector 110b is a midstream deflector, and the second frustoconical deflector 108b is a downstream deflector. That is, the first frustoconical deflector 106b is disposed upstream of the conical deflector 110b, and the conical deflector 110b is disposed upstream of the second frustoconical deflector 108b, relative to the flow direction 112 of the air flow 14 through the enclosure 26b (e.g., along the longitudinal direction 80). As shown, the deflectors 106b, 108b, 110b may be centered on a central axis 118b of the enclosure 26b. Each deflector 106b, 108b, and 110b further includes a respective outer edge 128b defining a plurality of tips 130b (e.g., triangular tips) with a plurality of passages 132b formed therebetween. The deflectors 34b also include ridges 126b, as similarly described above, configured to promote flow of liquid condensate 24 along upstream surfaces 124b of the deflectors 34b.

The condensate separator 22b includes ribs 114b extending from an inner surface 36b of the enclosure 26b to the deflectors 106b, 108b, and 110b. The ribs 114b are configured to couple to and support the deflectors 106b, 108b, and 110b within a cavity 28b defined by the enclosure 26b. The ribs 114b are also configured to facilitate flow of liquid condensate 24 from the deflectors 106b, 108b, and 110b to the inner surface 36b of the enclosure 26b. The ribs 114b include ridges 134b (e.g., linear ridges) protruding from surfaces of the ribs 114b. In the illustrated embodiment, each rib 114b is coupled to (e.g., attached to) the inner surface 36b of the enclosure 26b. The ribs 114b are also coupled to the deflector 108bat respective inner vertices 140b defined between respective adjacent tips 130b of the deflector 108b, and to the deflectors 106b and 110b at respective outer vertices 138 of the deflectors 106b and 110b. In some embodiments, one or more of the outer vertices 138b defined by one or more of the deflectors 106b, 108b, and 110b may extend to contact and/or attach to the inner surface 36b of the enclosure 26b. The inner surface 36b of the enclosure 26b further includes ridges 136b extending (e.g., linearly) along the inner surface 36b in the longitudinal direction 80 to promote flow of the liquid condensate along 24 the inner surface 36b toward a filter section 142b having a recess 144b and a filter 32b disposed in the recess 144b. In some embodiments, one or more of the ridges 136b of the inner surface 36b may intersect one or more of the outer vertices 138b of tips 130b of the deflectors 106b, 108b, and 110b that contact the inner surface 36b, as shown. As previously described, a liquid inlet 146b may be employed to wet or prime the filter 32b and a liquid outlet 146b may be employed to remove liquid (e.g., the liquid condensate 24 and any liquid used to wet or prime the filter 32b) from the condensate separator 22b.

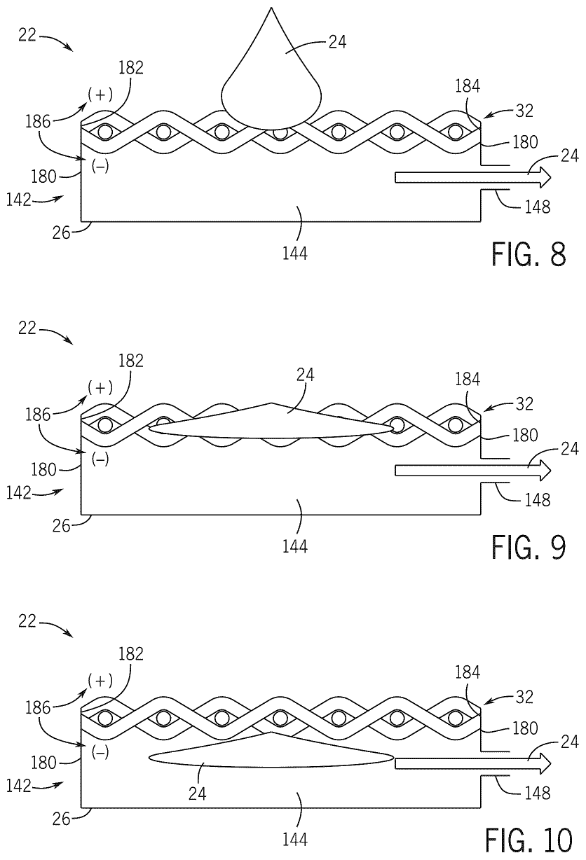

FIGS. 8-10 are schematics of a portion of an embodiment of the condensate separator 22, illustrating a filter section 142 of the condensate separator 22 having a filter 32. As discussed above, the enclosure 26 (illustrated in FIG. 1) of the condensate separator 22 may define a recess 144 configured to accommodate and retain the filter 32 (e.g., mesh filter) therein. For example, the filter 32 may be a mesh or porous structure that is secured to walls 180 of the enclosure 26 (e.g., walls defining the recess 144). In some embodiments, the filter 32 includes an annular configuration configured to extend along the enclosure 26 and to surround (e.g., in the circumferential direction 84) the air flow path 38 extending through the enclosure 26. The filter 32 may be retained within the recess 144 and/or may be secured to the walls 180 of the enclosure 26 in any suitable manner. For example, an adhesive (e.g., epoxy) may be applied to a first edge 182 (e.g., upstream edge) and to a second edge 184 (e.g., downstream edge) of the filter 32 to secure the filter 32 to the walls 180. Additionally or alternatively, the filter 32 may be coupled to the walls 180 via one or more solder bonds, one or more fasteners (e.g., one or more bolted joints), one or more welds, or one or more other coupling mechanisms.

Liquid condensate 24 separated from the air flow 14 by the deflector assembly 30 may flow along the deflectors 34, the ribs 114, and the inner surface 36 of the enclosure 26 to flow toward the filter section 142. For example, liquid condensate 24 may flow along the inner surface 36 to the filter section 142 and, as shown in FIG. 8, may then contact the filter 32. The liquid condensate 24 may flow through and/or across the filter 32 and into the recess 144, as shown in FIGS. 9 and 10. In some embodiments, operation of the pump 44, which may be fluidly coupled to the liquid outlet 148, may generate a suction force that draws the liquid condensate 24 across the filter 32 and into the recess 144 (e.g., reservoir). That is, the pump 44 may operate to generate a pressure differential 186 (e.g., vacuum) that draws liquid condensate 24 across the filter 32 and into the recess 144.

The liquid condensate 24 may collect and/or accumulate within the recess 144, in some embodiments. Further, as discussed above, the recess 144 may also be supplied with the liquid 42 from the liquid supply flow path 40 to enable wetting and/or saturation of the filter 32. In this way, a force of the pressure differential 186 (e.g., suction force) generated by the pump 44 and acting on the liquid condensate 24 may be enhanced to further improve collection of the liquid condensate 24 within the recess 144. The liquid condensate 24 collected in the recess 144 may be drawn out of the recess 144 via the liquid outlet 148 by the pump 44 of the liquid supply flow path 40, as previously discussed above.

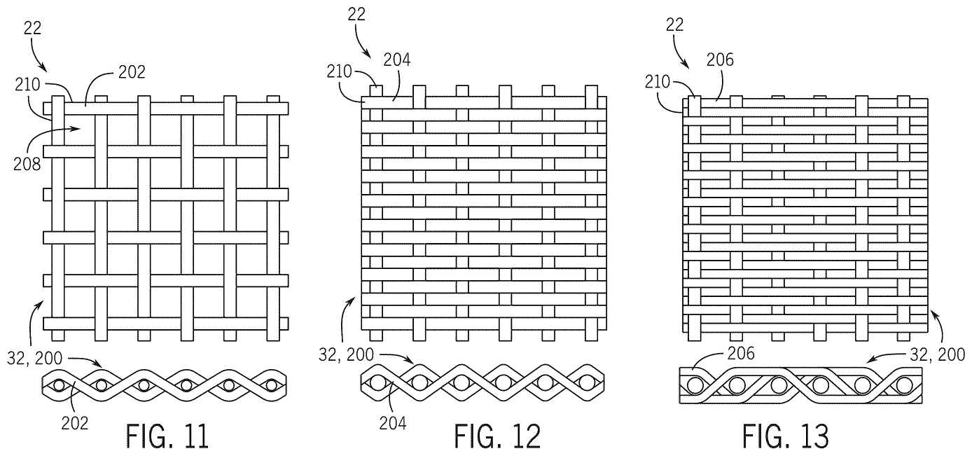

The filter 32 may include any suitable structure and/or material configured to facilitate the functionality described here. For example, the filter 32 may include woven material, such as a woven fabric, plastic (e.g., 3-D printed plastic), stainless-steel material, or other metallic material(s), configured to improve collection and removal of liquid condensate 24 via the condensate separator 22. FIGS. 11-13 are multiview projections of embodiments of a mesh filter 200 that may be utilized as the filter 32 of the condensate separator 22 described above. Specifically, FIG. 11 is a multiview projection of an embodiment of the mesh filter 200 including a straight weave 202 configuration, FIG. 12 is a multiview projection of an embodiment of the mesh filter 200 including plain Dutch weave 204 configuration, and FIG. 13 is a multiview projection of an embodiment of the mesh filter 200 including a twill Dutch weave 206 configuration.

While each of the embodiments illustrated in FIGS. 11-13 may be utilized to remove a substantial portion of the liquid condensate 24 from the air flow 14 in the condensate separator 22, in certain embodiments and/or operating conditions, the plain Dutch weave 204 of FIG. 12 and the twill Dutch weave 206 of FIG. 13 may provide enhanced performance over the straight weave 202 of FIG. 11. Each of the above-described embodiments may include pores 208 formed between strands 210 of the woven material, as shown in FIG. 11, where each pore 208 includes a dimension (e.g., length, width, diameter) of less than or equal to approximately 5-100 microns. Such pore sizes may improve liquid condensate 24 capture and/or improve cleanliness (e.g., block or reduce bacterial growth) of the filter 32. While the pores 208 are not shown in FIGS. 12 and 13 due to size/scale of the drawings, it should be understood that the pores 208 are formed between the strands 210 of woven material in FIGS. 12 and 13.

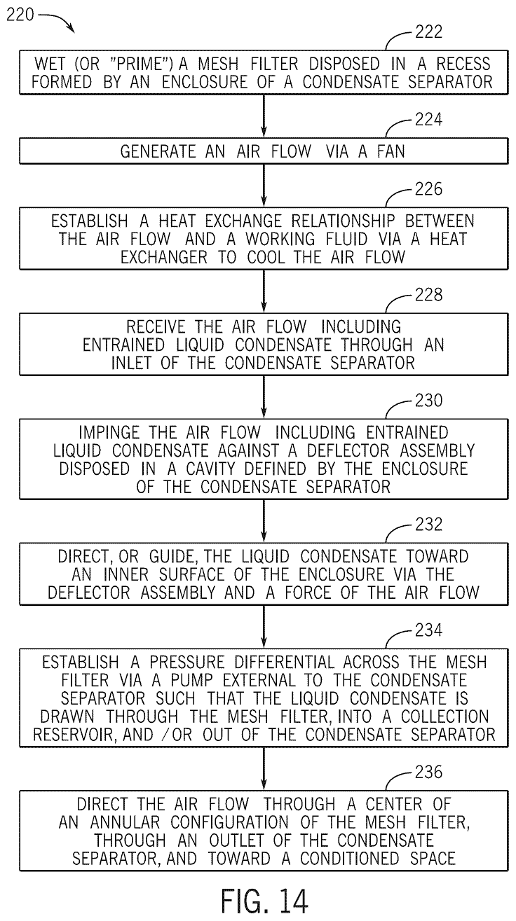

FIG. 14 is a process flow diagram illustrating an embodiment of a method 220 of operating the air conditioning system 10 of FIG. 1. An order of the steps in the method 220 illustrated in FIG. 14 may indicate the sequence of a particular embodiment but should not be taken as implying a sequence of every embodiment of the method 220, as other orders are also possible. Further, in certain embodiments, the method 220 may exclude certain steps illustrated in FIG. 14 and described below, and/or may include other steps not illustrated in FIG. 14 and not described below. FIG. 14 is merely an embodiment of the method 220, although other embodiments of the method 220 in accordance with the present disclosure are also possible.

In the illustrated embodiment, the method 220 includes wetting (block 222), or priming/saturating, a mesh filter disposed in a recess formed by an enclosure of a condensate separator. As previously described, the mesh filter may be wetted via a liquid (e.g., water) of a liquid circuit (e.g., water circuit) that may be employed as a part of, or interact with, a gray water circuit. Wetting the mesh filter may promote the formation of a pressure differential (e.g., via surface tension generated by wetting the mesh filter) across the mesh filter that encourages movement of liquid condensate toward or into the mesh filter. Further, wetting the mesh filter may improve a suction performance associated with a pump utilized to draw the liquid condensate across the filter and/or to draw liquid condensate out of the condensate separator, as described in greater detail below with respect to later steps of the method 220.

The method 220 also includes generating (block 224) an air flow via a fan or blower. The air flow may include cabin or return air (e.g., from a conditioned space), ventilation or supply air (e.g., from an electrolysis or air filtration assembly), or a combination thereof. The method 220 also includes establishing (block 226) a heat exchange relationship between the air flow and a working fluid via a heat exchanger, such that the air flow is cooled by the working fluid. The working fluid may include, for example, water, glycol, a combination of water and glycol, refrigerant, or other suitable heat transfer fluid. Further, the working fluid may be cooled (e.g., via heat transfer with the air flow) and biased through the heat exchanger. As discussed above, the heat exchange relationship established between the working fluid and the air flow may result in condensation of vapor within the air flow. The vapor may condense to form liquid condensate, which may form or accumulate on surfaces of the heat exchanger. In some instances, the cooled air flow may contain entrained liquid condensate (e.g., liquid droplets) as the cooled air flow is discharged from the heat exchanger. As previously described, it is desirable to remove the liquid condensate from the air flow prior to delivery of the air flow to downstream spaces (e.g., other air conditioning componentry, the conditioned space or cabin, etc.).

The method 220 also includes receiving (block 228) the air flow including the liquid condensate droplets through an inlet of the condensate separator (e.g., into an enclosure of the condensate separator). The method 220 also includes impinging (block 230) the air flow including entrained liquid condensate against a deflector assembly disposed in a cavity defined by the enclosure of the condensate separator. In doing so, the liquid condensate may accumulate on various deflectors (e.g., one or more conical deflectors, one or more frustoconical deflectors) of the deflector assembly.

Further, the method 220 includes directing (block 232), or guiding, the liquid condensate toward an inner surface of the enclosure of the condensate separator via the deflector assembly and a force of the air flow. As previously described, the deflector assembly may include at least one frustoconical deflector and at least one conical deflector nested in a stacked configuration and disposed in the cavity of the condensate separator. The air flow may force the liquid condensate along surfaces (e.g., upstream surfaces) of the deflectors toward the inner surface of the enclosure, and then along the inner surface toward the mesh filter. As previously described, each of the deflectors may include a plurality of outer tips collectively forming a serrated or stelliform geometry, for example, at a downstream end of the deflector. Additionally or alternatively, ribs may couple the outer tips of the deflectors, or some other location or feature of the deflectors, to the inner surface of the enclosure. In some embodiments, the air flow may force at least a portion of the liquid condensate from the deflectors and toward the inner surface of the enclosure via the ribs.

The method 220 also includes establishing (block 234) a pressure differential across the mesh filter via a pump external to the condensate separator such that the liquid condensate is drawn through the mesh filter, into or toward a collection point (e.g., container, reservoir), and/or out of the condensate separator. The performance of the suction generated by the pump may be improved by wetting the mesh filter in block 222 of the method 220. Further, the pressure differential generated by the external pump may block air bubbles from entering, or reduce an amount of air bubbles entering, the collection point (e.g., container, reservoir), the liquid outlet from the condensate separator, and/or a liquid circuit (e.g., water circuit) corresponding to the external pump.

The method 220 also includes directing (block 236) the air flow through a center of an annular configuration of the mesh filter, through an outlet of the condensate separator, and toward a conditioned space (e.g., cabin). For example, as previously described, the mesh filter may form a ring-shaped geometry that is attached to the inner surface of the enclosure of the condensate separator. As the mesh filter removes the liquid condensate from the air flow, the air flow is directed through the center of the ring-shaped geometry of the mesh filter, through the outlet of the condensate separator, and toward the conditioned space (e.g., cabin). The condensate separator may be configured to remove a substantial portion of the liquid condensate entrained in the air flow (e.g., approximately 90-99% of the liquid condensate, or more than 95% of the liquid condensate) such that the air flow is delivered to downstream componentry and/or the conditioned space (e.g., cabin) without a substantial amount of the entrained liquid condensate.

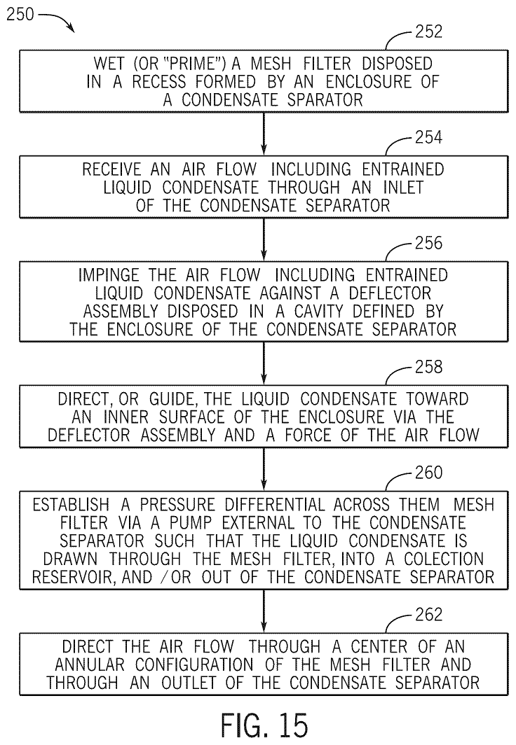

FIG. 15 is a process flow diagram illustrating an embodiment of a method 250 of separating a liquid condensate from an air flow via a condensate separator. An order of the steps in the method 250 illustrated in FIG. 15 may indicate the sequence of a particular embodiment but should not be taken to as implying a sequence of every embodiment of the method 250, as other orders are also possible. Further, in certain embodiments, the method 250 may exclude certain steps illustrated in FIG. 15 and described below, and/or may include other steps not illustrated in FIG. 15 and not described below. FIG. 15 is merely an embodiment of the method 250, although other embodiments of the method 250 in accordance with the present disclosure are also possible.

In the illustrated embodiment, the method 250 includes wetting (block 252), or priming/saturating, a mesh filter disposed in a recess formed by an enclosure of a condensate separator. Wetting the mesh filter may promote the formation of a pressure differential (e.g., via surface tension generated by wetting the mesh filter) across the mesh filter that encourages movement of liquid condensate toward or into the mesh filter. Further, wetting the mesh filter may improve a suction performance associated with a pump utilized to draw the liquid condensate across the mesh filter and/or to draw liquid condensate out of the condensate separator, as described in greater detail below with respect to later steps of the method 250.

In the illustrated embodiment, the method 250 includes receiving (block 254) an air flow including entrained liquid condensate (e.g., liquid droplets) via an inlet of the condensate separator. In some embodiments, the air flow may correspond to an air conditioning system. For example, the air flow may be generated by a fan and passed over a heat exchanger prior to the condensate separator receiving the air flow via the inlet.

The method 250 also includes impinging (block 256) the air flow including entrained liquid condensate against a deflector assembly disposed in a cavity defined by the enclosure of the condensate separator. In doing so, the liquid condensate may accumulate on surfaces (e.g., upstream surfaces) of various deflectors (e.g., one or more conical deflectors, one or more frustoconical deflectors) of the deflector assembly.

The method 250 also includes directing (block 258), or guiding, the liquid condensate via the deflector assembly and toward an inner surface of an enclosure of the condensate separator via the deflector assembly and a force of the air flow. In some embodiments, the air flow forces the liquid condensate along the surfaces (e.g., upstream surfaces) of the deflectors, along ribs coupling the deflectors with the inner surface of the enclosure, and onto the inner surface. Additionally or alternatively, the deflectors in certain embodiments may be directly coupled or otherwise abutting the inner surface such that at least a portion of the liquid condensate is forced directly onto the inner surface from the deflectors.

The method 250 also includes establishing (block 260) a pressure differential across a mesh filter via a pump external to the condensate separator such that the liquid condensate is drawn through the mesh filter, into or toward a collection point (e.g., container, reservoir), and/or out of the condensate separator. The suction performance of the suction generated by the pump may be improved by wetting the mesh filter in block 252 of the method 250. Further, the pressure differential generated by the external pump may block air bubbles from entering, or reduce an amount of air bubbles entering, the collection point (e.g., container, reservoir), the liquid outlet from the condensate separator, and/or a liquid circuit (e.g., water circuit) corresponding to the external pump.

The method 250 also includes directing (block 262) the air flow through a center of an annular configuration of the mesh filter and through an outlet of the condensate separator. For example, as previously described, the mesh filter may form a ring-shaped geometry that is attached to the inner surface of the enclosure of the condensate separator. As the mesh filter removes the liquid condensate from the air flow, the air flow is directed through the center of the ring-shaped geometry of the mesh filter and through the outlet of the condensate separator. In certain embodiments, the air flow is directed through the outlet and toward a conditioned space. However, other applications of the condensate separator and the method 250 illustrated in FIG. 15 and described above are also possible.

Technical benefits of the present disclosure include improves separation of entrained liquid from an air flow in a microgravity environment, improved condensate capture efficiency in air conditioning systems employed in microgravity environments, improved resiliency of condensate capture features against failure modes, and reduced footprint and weight of such condensate capture features.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A condensate separator comprising:
an enclosure defining a cavity configured to receive an air flow having a liquid condensate entrained in the air flow;
a deflector assembly disposed in the cavity and configured to separate the liquid condensate from the air flow and to guide the liquid condensate toward an inner surface of the enclosure; and
a filter disposed in the cavity and configured to receive the liquid condensate from the inner surface of the enclosure.

2. The condensate separator of claim 1, wherein the enclosure defines an inlet configured to direct the air flow into the cavity and an outlet configured to discharge the air flow from the cavity, wherein the deflector assembly is disposed within the cavity upstream of the filter relative to a flow direction of the air flow through the cavity.

3. The condensate separator of claim 1, wherein the deflector assembly comprises a frustoconical deflector and a conical deflector stacked within the cavity, wherein the frustoconical deflector and the conical deflector are offset from one another along a longitudinal axis of the condensate separator.

4. The condensate separator of claim 3, wherein the deflector assembly comprises an additional frustoconical deflector.

5. The condensate separator of claim 4, wherein:
the additional frustoconical deflector is upstream of the conical deflector relative to a flow direction of the air flow through the cavity; and
the frustoconical deflector is upstream of the additional frustoconical deflector, relative to the flow direction of the air flow through the cavity.

6. The condensate separator of claim 5, wherein:
the conical deflector comprises a downstream edge defining a plurality of triangular tips of the conical deflector; and
the frustoconical deflector comprises an additional downstream edge defining an additional plurality of triangular tips of the frustoconical deflector.

7. The condensate separator of claim 5, wherein:
the conical deflector is coupled to the inner surface of the enclosure via a plurality of ribs; and
the frustoconical deflector is coupled to the inner surface of the enclosure via the plurality of ribs.

8. The condensate separator of claim 1, wherein the filter comprises a mesh filter, and the mesh filter comprises Dutch weave formed from stainless-steel, plastic, or fabric.

9. The condensate separator of claim 1, wherein the enclosure comprises a liquid outlet fluidly coupled to a recess formed in the enclosure, the filter is disposed within the recess, and the liquid outlet is configured to discharge the liquid condensate from the enclosure.

10. The condensate separator of claim 1, wherein the enclosure defines an inlet configured to direct the air flow into the cavity and an outlet configured to discharge the air flow from the cavity, wherein the deflector assembly is disposed within the cavity upstream of the filter relative to a flow direction of the air flow though the cavity, wherein the enclosure comprises a throat section disposed downstream of the inlet and upstream of at least a portion of the deflector assembly relative to the flow direction of the air flow through the cavity, wherein the throat section comprises a first cross-sectional width, and wherein:
the first cross-sectional width is less than a second cross-sectional width of the inlet;
the first cross-sectional width is less than a third cross-sectional width of the outlet; or
the first cross-sectional width is less than both the second cross-sectional width and the third cross-sectional width.

11. An air conditioning system comprising:
a condensate separator comprising an enclosure defining a cavity configured to receive an air flow from a heat exchanger of the air conditioning system, wherein a liquid condensate is entrained in the air flow;
a deflector assembly disposed in the cavity of the condensate separator, wherein the deflector assembly comprises a plurality of deflectors arranged within the cavity and configured to separate the liquid condensate from the air flow and to guide the liquid condensate toward an inner surface of the enclosure; and
a filter disposed within a recess of the enclosure, wherein the filter is configured to receive the liquid condensate from the inner surface of the enclosure, and the filter is downstream of the deflector assembly relative to a flow direction of the air flow through the enclosure.

12. The air conditioning system of claim 11, wherein the enclosure comprises a liquid inlet configured to receive a liquid from a liquid circuit and to direct the liquid into the recess to wet the filter.

13. The air conditioning system of claim 12, further comprising the liquid circuit fluidly coupled to the liquid inlet, wherein enclosure comprises a liquid outlet fluidly coupled to the liquid circuit, and the liquid outlet is configured to direct the liquid, the liquid condensate, or both from the recess to the liquid circuit.

14. The air conditioning system of claim 13, further comprising a pump disposed along the liquid circuit and configured to draw the liquid condensate through the filter and out of the enclosure.

15. The air conditioning system of claim 11, wherein the plurality of deflectors comprises:
a frustoconical deflector having a central opening; and
a conical deflector disposed downstream of the frustoconical deflector relative to the flow direction of the air flow through the enclosure.

16. The air conditioning system of claim 15, further comprising a plurality of ribs attached to the inner surface of the enclosure and attached to the frustoconical deflector and to the conical deflector, wherein the frustoconical deflector and the conical deflector are each configured to guide the liquid condensate to the plurality of ribs, and the plurality of ribs is configured to guide the liquid condensate to the inner surface of the enclosure.

17. The air conditioning system of claim 16, further comprising a plurality of ridges configured to guide the liquid condensate toward the filter, wherein the plurality of ridges is formed on the frustoconical deflector, the conical deflector, the plurality of ribs, the inner surface of the enclosure, or any combination thereof.

18. A method of separating a liquid condensate from an air flow, the method comprising:
receiving the air flow and the liquid condensate entrained in the air flow into a cavity of an enclosure of a condensate separator via an inlet of the enclosure;
impinging the air flow and the liquid condensate entrained in the air flow against a deflector assembly disposed in the cavity;
guiding the liquid condensate separated from the air flow via the deflector assembly toward an inner surface of the enclosure;
guiding the liquid condensate via the inner surface of the enclosure to a filter disposed in the cavity;
discharging the liquid condensate from the enclosure via a liquid outlet formed in the enclosure; and
directing the air flow through an outlet of the enclosure.

19. The method of claim 18, further comprising:
directing a liquid from a liquid circuit into a recess of the enclosure;
wetting the filter with the liquid in the recess; and
drawing the liquid and the liquid condensate out of the enclosure via the liquid outlet.

20. The method of claim 18, further comprising directing the liquid condensate from the deflector assembly and to the inner surface of the enclosure via a plurality of ribs coupling the deflector assembly with the inner surface of the enclosure.
